(19) United States
(12) Patent Application Publication
(10) Pub. No.: US 2006/0227111 A1
(43) Pub. Date: Oct. 12, 2006

(54) Keyboard to be inside page of notebook

(76) Inventor: Chun-Chien Chou, Sinjhuang City (TW)

Correspondence Address: TROXELL LAW OFFICE PLLC;SUITE 1404, 5205 LEESBURG PIKE, FALLS CHURCH, VA, 22041, US

(21) Appl. No.: 11/092,870

(22) Filed: Mar. 30, 2005

(51) Int. Cl. G09G 5/00

(52) U.S. Cl. 345/168

(57) ABSTRACT

A keyboard to be an inside page of a notebook comprises a main body on which a keyboard region, an electronic region having a transmission device mounted therein, a mounting region having a liftable cover mounted thereon, and a connection part are mounted. A top plate is pivotally connected to the top edge of the cover. After lifting up the cover, the bottom edge of the top plate is leant against a supporting surface for providing the mounting region with a more powerful supporting force for steadily mounting a hand-held electronic apparatus. The connection part comprises through holes corresponding to the loose-leaf binders in positions. By means of the keyboard region of the main body, the data are inputted into the hand-held electronic apparatus. The keyboard can couple with any notebook having the loose-leaf binders mounted therein through the connection part of the main body to facilitate carry.

### FIELD OF THE INVENTION

The present invention relates to a keyboard to be an inside page of a notebook, which is easy to carry and suitable for any notebook with loose-leaf binders, and more particularly to a keyboard that facilitates data input of a hand-held electronic apparatus such as a personal digital assistant (PDA), a mobile phone, or the like.

### BACKGROUND OF THE INVENTION

Mobile phone and PDA are nowadays popular hand-held electronic apparatuses. In these two hand-held electronic apparatus, data input is accomplished by use of their own buttons or handwriting input function. The apparatuses with the handwriting input function are very expensive and not popular so only few apparatuses provide the function of handwriting input. Accordingly, the data are generally inputted through their own buttons. It causes minor influence if only few data need to be inputted. However, it is troublesome if the user want to input masses of data. In that case, an external type keyboard is provided to connect with the hand-held electronic apparatus.

The conventional external type keyboard is usually classified into a hand-held type or a desktop type. It is not easy for the user to operate the keyboard since the buttons of the hand-held type keyboard are too small. When the user holds the handhold type keyboard for operation, the shake causes the keyboard to fall off or results in the weak signal if the connection mechanism between the keyboard and the PDA is not good enough. Another operation way is to posit the external keyboard on a planar surface, but it is confined to the operation location. Therefore, the conventional connection and mounting methods for the keyboard and the PDA are troublesome and inconvenient. Moreover, the keyboard only can be held by hand or posited on the planar surface for operation since its structure limits the input operation. Because the conventional keyboard is not suitable for being posited on the lap directly for typewriting, it provides less mobility. Accordingly, the conventional keyboard needs to be improved for use.

Moreover, the hand-held electronic apparatus can record or process data by means of the external type keyboard. Nevertheless, the conventional handwriting method for making a note on a notebook cannot be avoided. When the user goes out, he always needs to carry the notebook and the handhold electronic apparatus (e.g. PDA and mobile phone) at the same time while they are not integrated with one another. Thus, it is very inconvenient for the user to carry and use them.

Accordingly, the present inventor has been made diligent studies with a quiet mind to provide a keyboard to be an inside page of a notebook for the consumer, wherein this keyboard is easy to carry and able to couple with various notebooks with loose-leaf binders.

### SUMMARY OF THE INVENTION

It is the main object of the present invention to provide a keyboard to be an inside page of a notebook, wherein the keyboard is easy to carry and able to couples with the notebook.

It is another object of the present invention to provide a keyboard to be an inside page of a notebook, wherein the keyboard is provided to fit for various notebooks having loose-leaf binders.

It is still another object of the present invention to provide a keyboard to be an inside page of a notebook, wherein the keyboard is angle-adjustable and provides a more powerful supporting force for steadily mounting the hand-held electronic apparatus.

In order to achieve the aforementioned object, the present invention discloses a keyboard to be an inside page of a notebook, wherein the keyboard comprises a main body on which a keyboard region, an electronic region having a transmission device mounted therein, a mounting region having a liftable cover mounted thereon, and a connection part are located. A top plate is pivotally connected to the top edge of the cover. After lifting up the cover, the bottom edge of the top plate is leant against a supporting surface for providing the mounting region with a more powerful supporting force for steadily mounting a hand-held electronic apparatus. The connection part comprises through holes corresponding to the loose-leaf binders in positions. By means of the keyboard region of the main body, the data are inputted into the hand-held electronic apparatus. The keyboard can couple with any notebook having the loose-leaf binders mounted therein through the connection part of the main body

The other features and preferred embodiments of the present invention will now be described with reference to the accompanying drawings.

### BRIEF DESCRIPTION OF THE DRAWINGS

FIG. 1 is an elevational view showing the outward appearance of a first preferred embodiment of the present invention.

FIG. 2 is a schematic state diagram showing that the keyboard is coupled with the notebook in accordance with the first preferred embodiment of the present invention.

FIG. 3 is a schematic usage diagram showing that the keyboard is coupled with the notebook in accordance with the first preferred embodiment of the present invention.

FIG. 4 is a diagram showing another application example in accordance with the first preferred embodiment of the present invention.

FIG. 5 is an exploded view of devices in accordance with a second preferred embodiment of the present invention.

FIG. 6 is an elevational view showing the outward appearance of a third preferred embodiment of the present invention.

FIG. 7 is a schematic enlarged view of rails and slides of FIG. 6.

### DETAILED DESCRIPTION OF THE PREFERRED EMBODIMENT

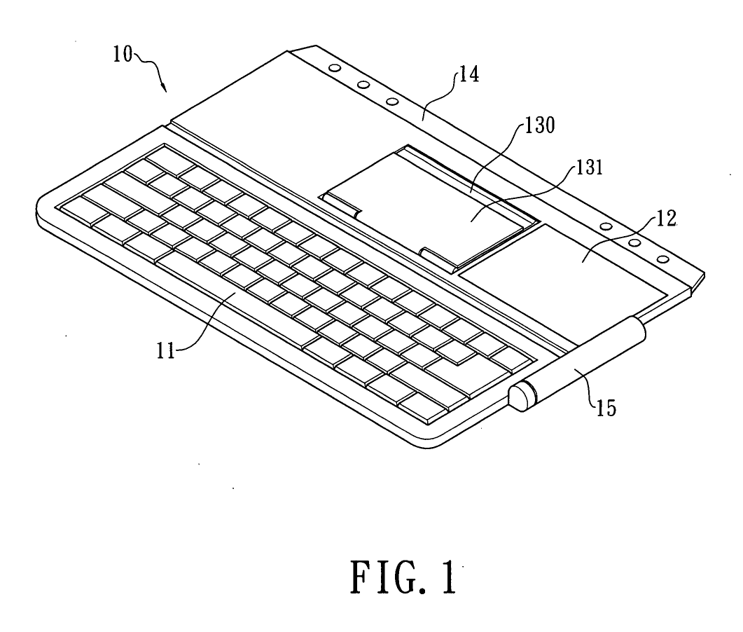

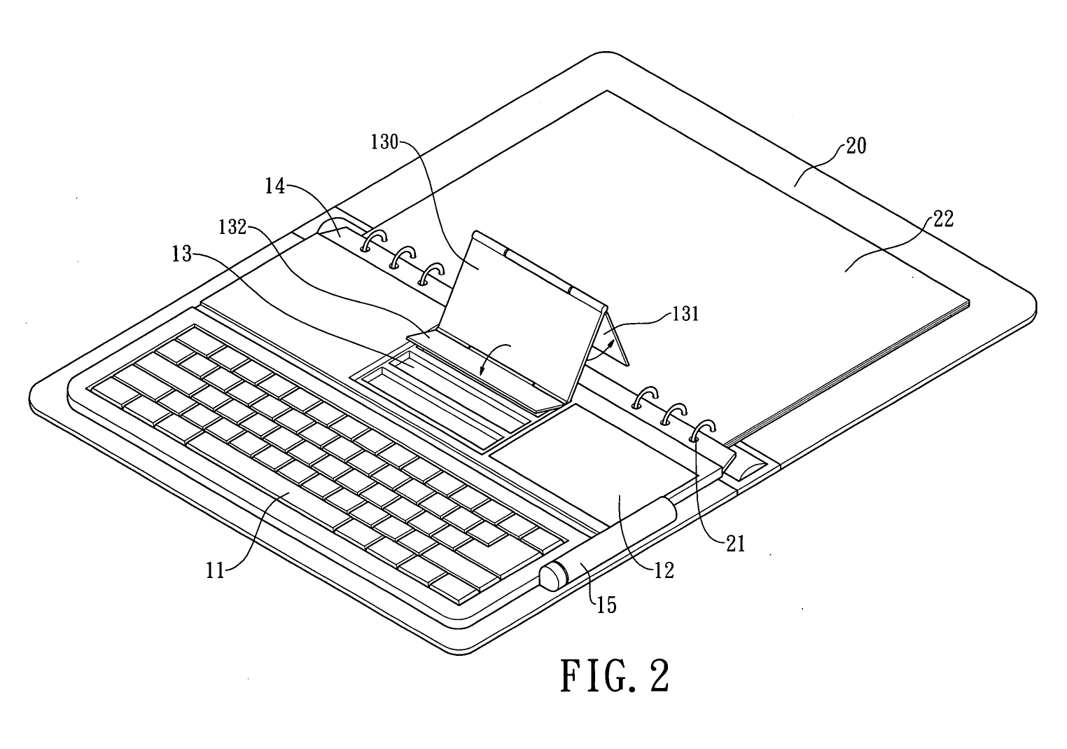

Referring to FIG. 1 and FIG. 2, the present invention comprises a main body 10 on which a keyboard region 11, an electronic region 12, a mounting region 13, a connection part 14, and a battery chamber 15 are mounted, wherein the keyboard region 11 is mounted on the lower portion of the main body 10, and the mounting region 13 and the electronic region 12 are mounted above the keyboard region 11. A transmission device such as a wireless transmission device (e.g. a Bluetooth chip module) or a wired transmission device having a transmission terminal is mounted in the electronic region 12. This preferred embodiment gives priority to the wireless transmission device. Besides, a thin type rechargeable battery is mounted in the electronic region 12, and a battery charger (not shown) is used for charging the battery. Alternatively, a battery chamber 15 for holding the battery is connected to the lateral side of the electronic region 12 of the main body 10, wherein the bottom of the battery chamber 15 is located at the same level with the bottom of the main body 10. The mounting region 13 comprises several mounting spaces. If the wired transmission device is applied, the transmission terminal of the wired transmission device for electrically connecting to a transmission circuit of the electronic region 12 is mounted in one of the mounting spaces. In addition, a cover 130 with an angle-adjustable pivot is pivotally connected to the mounting region 13 such that the cover 130 can be lifted up to any angle. Besides, a top plate 131 is pivotally connected to the top end of the cover 130 to form a supporting back plate with a more powerful supporting force. The connection part 14 having several through holes is mounted on the top edge of the main body 10.

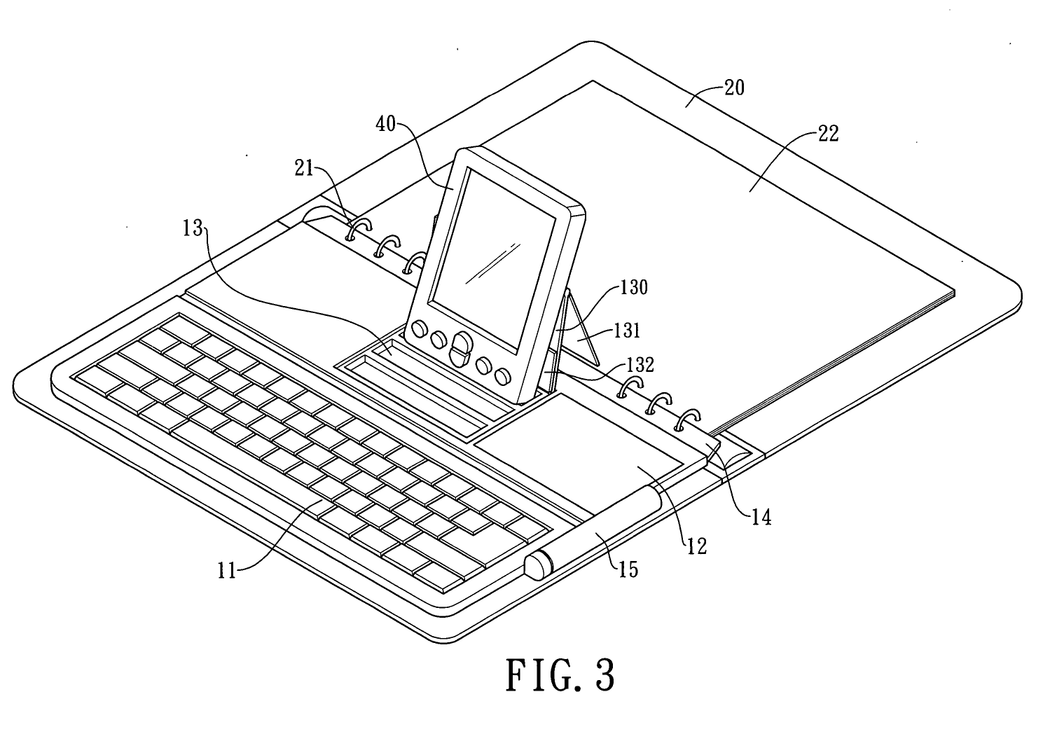

Referring to FIG. 2 and FIG. 3 simultaneously, the connection part 14 of the main body 10 is mounted to fit for the number of loose-leaf binders 21 in a notebook 20. The through holes of the connection part 14 are formed corresponding to the loose-leaf binders 21 in positions so the user can randomly choose a location for mounting the main body 10. The user just needs to choose the location for mounting the main body 10, then unlock the loose-leaf binders 21 for inserting them into the through holes of the connection part 14, and thereafter lock the loose-leaf binders 21 such that the main body 10 constitutes one inside page of the notebook 20. When the notebook 20 is folded up, the loose-leaf papers 22 can be contained within the protrudent room formed by the battery chamber 15 so the addition of the main body 10 will not destroy the original appearance of the notebook 20, thereby facilitating carry. When it is in use, the cover 130 of the mounting region 13 is lifted up to expose the inside mounting spaces and lean the bottom edge of the top plate 131 against the loose-leaf papers 22 (supporting plane), thereby facilitating the mounting of a hand-held electronic apparatus 40 such as a PDA to input masses of data. Besides, if the mounting spaces in the mounting region 13 are too small to hold the hand-held electronic apparatus, a bottom plate 132 may be pivotally connected to the bottom edge of the cover 130 to facilitate the mounting of the hand-held electronic apparatus by turning down the bottom plate 132. Furthermore, according to practical situations, the main body 10 and the notebook 20 are coupled with or separated from one another for synchronously making records through the PDA 40 and the notebook 20.

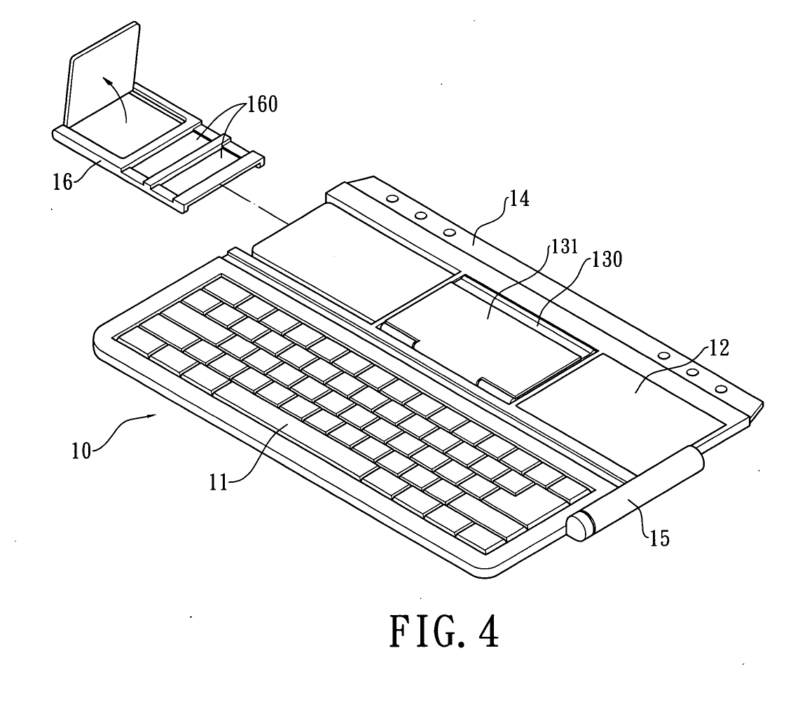

Referring to FIG. 4, a detachable mounting bracket 16 is further mounted on the main body 10 in the positions where the mounting the electronic region 12 and the mounting region 13 are located. The detachable mounting bracket 16 is movably connected with or separated from the main body 10. Several mounting spaces 160 are formed in the detachable mounting bracket 16, and a plate is pivotally connected to one side of the detachable mounting bracket 16, wherein a top plate (not shown) identical to the top plate 131 can be pivotally connected to the top edge of the plate by means of an angle-adjustable pivot. When the user puts the coupled main body 10 and notebook 20 on the lap for operation, and when the PDA 40 is not suitable to be posited on the mounting region 13, the detachable mounting bracket 16 is separated from the main body 10 and located on the top of a table. Thereafter, the plate of the detachable mounting bracket 16 is lifted up and the elevation angel of the plate can be adjusted by means of the angle-adjustable pivot, thereby leaning the bottom edge of the top plate pivotally connected to the plate against the tabletop. Next, the bottom end of the PDA 40 is put into one of these mounting spaces 160, and the top end of the PDA 40 is leant against the plate. Accordingly, the main body 10 (including notebook 20) can be put on the lap for operation without affecting the mounting position of the PDA 40.

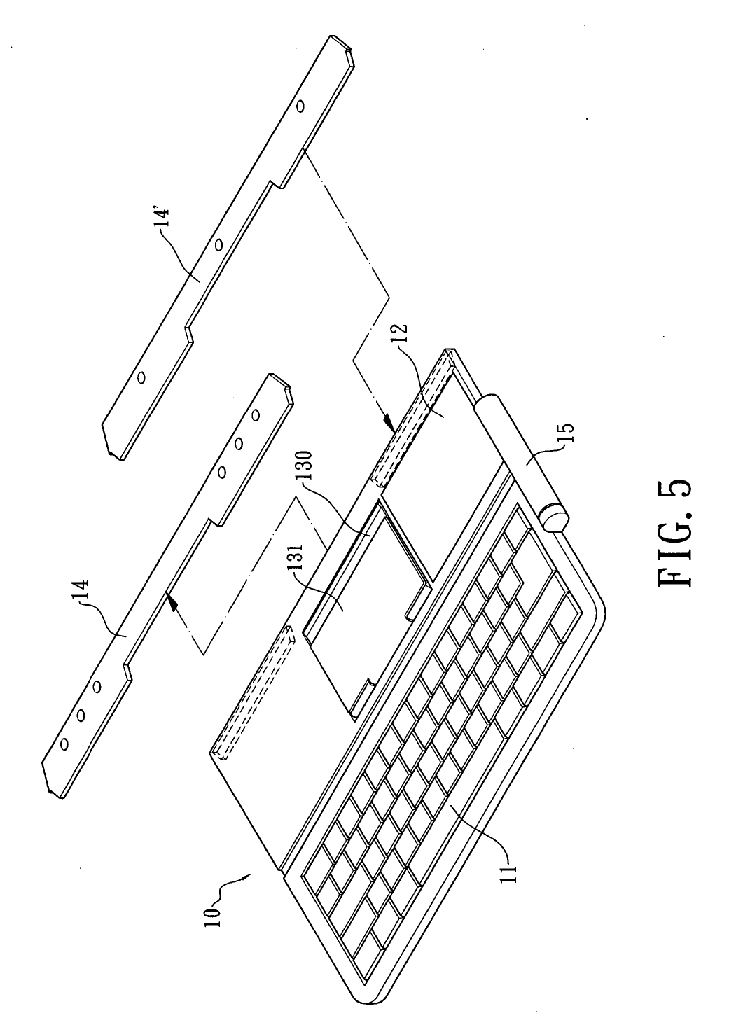

Referring to FIG. 5, a second preferred embodiment of the present invention is shown. The connection part 14 of the main body 10 is of a detachable and replaceable type. Because the loose-leaf binders of the commercial notebooks have various numbers, the connection parts 14, 14′ with different number of through holes can be mounted on a predetermined embedded trench of the main body 10 where the electronic region 12 and the mounting region 13 are located. Therefore, the main body 10 is suitable to various notebooks for use together.

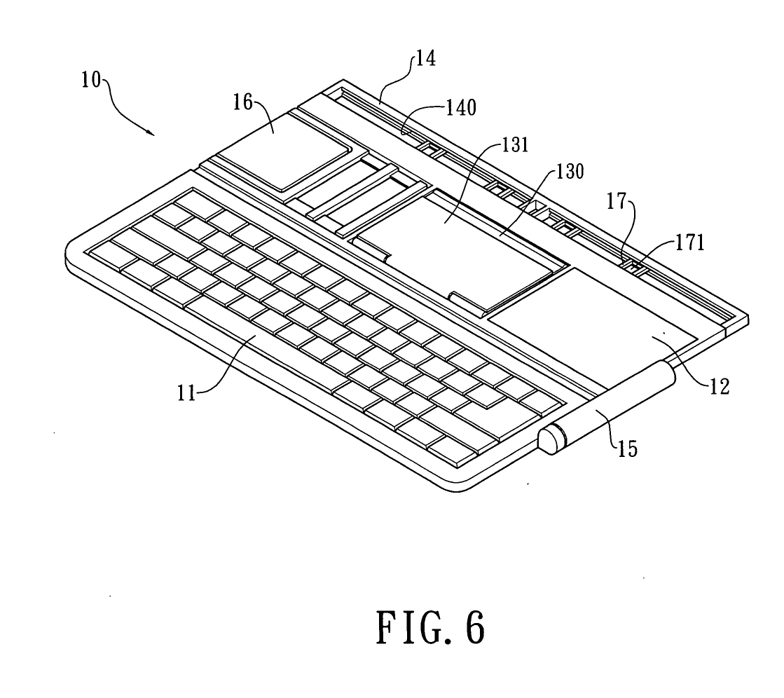

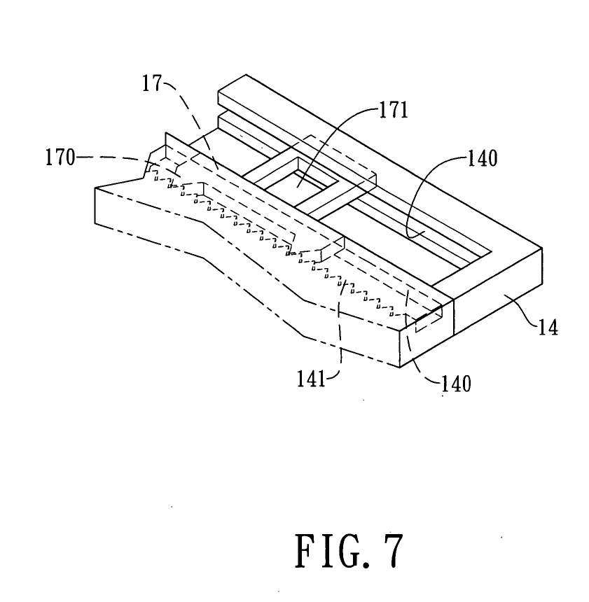

Referring further to FIG. 6 and FIG. 7, a third preferred embodiment of the present invention is shown. The main body 10 also comprises the keyboard region 11, the electronic region 12, the mounting region 13, the detachable mounting bracket 16, the battery chamber 15, and the connection part 14, wherein a large area trench is formed on the connection part 14. Two grooves are formed respectively on two longitudinal sides of this trench to form two rails 140, wherein sawtooth-shaped notches 141 are formed on the bottom surface of one of the rails 140, and a plurality of slides 17 are mounted between two rails 140. Each slide 17 has a sawtooth-shaped protrusion part 170 on both sides of its bottom, and a through hole 171 is formed in the front of this slide 17. By use of the sawtooth-shaped protrusion part 170 of the slide 17 and the sawtooth-shaped notches 141 of the rails 140, the slide 17 in the connection part 14 can be slid and locked so as to randomly shift the through hole 171 of the slide 17 to suitable for various notebooks with different numbers of loose-leaf binders.

Furthermore, the battery chamber 15 is not limited to be mounted beside the electronic region 12. The battery chamber 15 can be mounted beside the main body 10 in a position where the connection part 14 is not to be mounted.

On the basis of the description mentioned above, it is apparent that the present invention provides the following practical advantages.

1. The notebook and the keyboard are integrated with one another. Therefore, if the user wants to go out, he just needs to carry one notebook so he can simultaneously make a note and use the keyboard to connect with the hand-held apparatus such as PDA.

2. The through holes of the connection part of the main body are suited to the loose-leaf binders in a notebook so it is suitable for various numbers of loose-leaf binders.

3. In order to accomplish the optimum usage, the user is able to couple the main body with the notebook or separate them from one another in accordance with practical situations.

4. The hand-held electronic apparatus is located on the mounting region if there is a table. If there is no table and the user puts the main body on his lap, it is not fit to posit the hand-held electronic apparatus on the mounting region. On that occasion, the detachable mounting bracket can be separated from the main body to facilitate the mounting of the hand-held electronic apparatus.

5. The angle-adjustable cover on the mounting region optionally comprises the bottom plate or the top plate pivotally mounted on its inside bottom edge or outside top edge. When the cover is lifted up, the outside top plate can lean against the supporting surface to strengthen the supporting ability of the mounting region such that the hand-held electronic apparatus can be mounted slantwise to enable the user to watch the monitor clearly. If the mounting capacity of the mounting region is smaller than the dimension of the hand-held electronic apparatus, the inside plate can be turned down to facilitate the mounting of the hand-held electronic apparatus.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

On the basis of the aforementioned description, it is apparent that a keyboard to be an inside page of a notebook of the present invention can achieve the expected purposes. The present invention complies with all requirements of patent rules and is submitted for a patent.

What the invention claimed is:

1. A keyboard to be an inside page of a notebook comprising:
a main body comprising:
a keyboard region;
an electronic region having a transmission device mounted therein;
a mounting region having a plurality of mounting spaces formed therein, a first liftable cover being coupled to one side of said mounting region to form a supporting back plate by lifting up said first liftable cover for mounting a hand-held electronic apparatus; and
a connection part, wherein the data are inputted into said hand-held electronic apparatus by means of said keyboard region of said main body and said keyboard is coupled with said notebook having loose-leaf binders mounted therein by means of said connection part of said main body to facilitate carry.

2. The keyboard of claim 1, wherein said electronic region further comprises a thin type rechargeable battery mounted therein for supplying electric power.

3. The keyboard of claim 1, further comprising a battery chamber having a battery for supplying electric power, wherein said batter chamber is mounted beside said main body in a position where said connection part is not to be mounted.

4. The keyboard of claim 1, wherein said connection part and said main body are integrated with one another, and said connection part further comprises a plurality of through holes with a number corresponding to that of said loose-leaf binders.

5. The keyboard of claim 1, wherein said connection part is of a detachable and replaceable type, and said connection part further comprises: a plurality of through holes suitable for said loose-leaf binders with various specifications.

6. The keyboard of claim 5, wherein said connection part and said main body further comprise a protrusion part and an embedded trench for fitting one another.

7. The keyboard of claim 1, wherein said connecting part further comprises a large area trench having two grooves respectively on two longitudinal sides of said trench to form two rails such that a plurality of slides having through holes can slide in said rails.

8. The keyboard of claim 7, wherein said connecting part further comprises sawtooth-shaped notches on a bottom surface of one of said rails and sawtooth-shaped protrusion parts on both sides of the bottom of said slides.

9. The keyboard of claim 1, wherein said transmission device is a wired transmission device with a transmission terminal mounted in said mounting spaces of said electronic region or said first liftable cover.

10. The keyboard of claim 1, wherein said transmission device is a wireless transmission device.

11. The keyboard of claim 10, wherein said wireless transmission device is a Bluetooth chip module.

12. The keyboard of claim 1, wherein said main body further comprises a detachable mounting bracket with a second liftable cover.

13. The keyboard of claim 12, wherein said detachable mounting bracket further comprises a top plate pivotally connected to a top edge of said second liftable cover for increasing supporting ability

14. The keyboard of claim 12, wherein said detachable mounting bracket further comprises a bottom plate pivotally connected to a bottom edge of said second liftable cover for mounting said hand-held electronic apparatus.

15. The keyboard of claim 1, further comprising a top plate pivotally connected to a top edge of said first liftable cover on said mounting region for increasing supporting ability.

16. The keyboard of claim 1, further comprising a bottom plate pivotally connected to a bottom edge of said first liftable cover on said mounting region for mounting said hand-held electronic apparatus.
